(19) United States
(12) Patent Application Publication
(10) Pub. No.: US 2014/0337106 A1
(43) Pub. Date: Nov. 13, 2014

(54) COMPUTER-IMPLEMENTED METHODS AND SYSTEMS FOR PERFORMANCE TRACKING

(71) Applicant: ONCORPS, INC., Boston, MA (US)

(72) Inventors: Robert Suh, Brookline, MA (US); Laura Lafave, Bristol (GB); Peter Hallett, Bristol (GB)

(73) Assignee: ONCORPS, INC., Boston, MA (US)

(21) Appl. No.: 14/274,142

(22) Filed: May 9, 2014

Related U.S. Application Data
(60) Provisional application No. 61/822,018, filed on May 10, 2013.

(51) Int. Cl. G06Q 10/06

(52) U.S. Cl. CPC G06Q 10/06393
USPC 705/7.39

(57) ABSTRACT

Computer-implemented methods and systems enable real-time performance comparisons between users and peers by tracking user beliefs, observations, and responses to performance issues. The system operates in a series of cycles, where each user is asked to input outcome information for each cycle. The system tracks beliefs of users relating to the improvement of the outcome by asking the users to compare methods for achieving the outcome and to define their priorities. The system provides real-time charts to users such as heat maps and Gaussian curves, allowing users to observe the popularity and performance ranking of chosen priorities as compared to others.

### CROSS REFERENCE TO RELATED APPLICATION

This application claims priority from U.S. Provisional Patent Application No. 61/822,018 filed on May 10, 2013 entitled COMPUTER-IMPLEMENTED METHODS AND SYSTEMS, which is hereby incorporated by reference.

### BACKGROUND

Many large private and public organizations have adopted collaboration applications modeled after popular consumer collaboration sites. Many of these applications have default public sharing workflows, where profiles, interests, and requests are posted to large groups. Search and filtering are principally based on key word searches from postings, “likes,” and group affiliations. Most messages are broadcasted to all members of large groups, creating an overwhelming volume of often irrelevant messages for users. There are low engagement levels in professional organizations.

Enterprises seek to improve performance with data derived from surveys and transactional systems, which often provide one-time insights to senior leaders but often do not reach the people deeper in the organization. The data are often conducted as blind surveys or transactional collections not connected to the individual once it is presented to the viewer.

### BRIEF SUMMARY

In accordance with one or more embodiments, a computer-implemented method is provided for tracking performance of a plurality of users. Each of the users operate a computer client device communicating with a computer server system over a communications network. The method includes the steps of: (a) receiving responses to one or more profile questions from each of said plurality of users and storing the responses in a database as part of each user's profile; (b) receiving from each of said plurality of users information on performance of the user in a given time cycle relating to a specified outcome, and storing the information in the database as part of the user's profile; (c) comparing the information on the performance of the user to information stored in the database on the performance of other users to generate a performance comparison, and presenting a graphical representation of the performance comparison to the user in real-time to step (b); (d) presenting to the user a set of alternative methods for potentially improving achievement of the outcome, receiving a response from the user with a selected alternative method, and presenting to the user in real-time information on the popularity of the alternative methods as selected by the other users; and (e) repeating steps (b) through (d) for a plurality of time cycles.

### BRIEF DESCRIPTION OF THE DRAWINGS

FIG. 1 illustrates an exemplary network, in which systems in accordance with various embodiments may be implemented.

FIG. 2 illustrates an exemplary TOM (topic, outcome, method) model in the exemplary context of home energy conservation in accordance with one or more embodiments.

FIG. 3 is a simplified flowchart showing use the TOM taxonomy to interact with and see interactive data in accordance with one or more embodiments.

FIG. 4 illustrates a screen or window displaying exemplary interactive topics delivered to a user in accordance with one or more embodiments.

FIG. 5 illustrates a screen or window displaying exemplary outcome sharing dials for a user to share data in accordance with one or more embodiments.

FIG. 6 illustrates a screen or window displaying exemplary user performance compared to peers in the same topic and sub-topic category in accordance with one or more embodiments.

FIG. 7 is a simplified flowchart illustrating exemplary use of a system for establishing private benchmarking libraries in accordance with one or more embodiments.

FIG. 8 illustrates a screen or window enabling an exemplary private library to be set up for an organization in accordance with one or more embodiments.

FIG. 9 illustrates a screen or window allowing authorized participants in an exemplary private library to write new topics, outcomes, and methods to the library in accordance with one or more embodiments.

FIG. 10 illustrates a screen or window enabling users to select an exemplary topic, outcome, method combination and see data panels where they may share-and-compare benchmark data pertaining to that particular combination in accordance with one or more embodiments.

FIG. 11 is a simplified flow chart illustrating an exemplary matching workflow for experts in accordance with one or more embodiments.

FIG. 12 illustrates a screen or window showing an exemplary user-controlled matching process in accordance with one or more embodiments.

FIG. 13 is a simplified flow chart illustrating presentation of exemplary tracks beliefs, observations, and responses to a user in accordance with one or more embodiments.

FIG. 14 illustrates a screen or window showing presentation of a user's relative standing on a Gaussian curve in accordance with one or more embodiments.

FIG. 15 is a screen or window illustrating an exemplary 2×2 matrix displayed to a user in accordance with one or more embodiments.

FIG. 16 is a screen or window illustrating an exemplary decision tree displayed to a user in accordance with one or more embodiments.

FIG. 17 illustrates a screen or window showing presentation of exemplary methods and percentages to users in accordance with one or more embodiments.

FIGS. 18A and 18B are screens or windows showing an exemplary presentation of YES, NO, ONLY IF questions and branching questions to the user in accordance with one or more embodiments.

FIG. 19 is a diagram illustrating an exemplary process for determining and displaying a decision making profile for a user in accordance with one or more embodiments.

FIG. 20 is a screen or window showing presentation of an exemplary heat map presenting data by the union of different groups to which the user belongs in accordance with one or more embodiments.

FIG. 21 is a screen or window showing how authorized users can create questions configured in an application in accordance with one or more embodiments.

### DETAILED DESCRIPTION

Various embodiments described in further detail below are directed to computer-implemented methods and systems for displaying real-time performance data to individuals, tracking their priorities and decisions, matching experts and enabling sharing of best practices using an interactive, analytic index as the basis for information capture. The system presents real-time performance rankings to users to help them make better decisions.

As users interact with the system, each click is time-stamped and categorized by topic, outcome, and method in a collaborative, filtered database. All other users are compared simultaneously. Methods, priorities and actions that correlate to higher performers are displayed in heat maps and Gaussian curves. The system calculates the standard deviation of achieving a top quartile outcome for each method, based on the actual reported performance of all other users, converts this into heat map colors or statistical odds predictions for a given method, priority or decision.

The system builds an analytic profile of each user's pattern of decision-making by measuring the user's beliefs, observations, and responses to the application. Beliefs are measured by asking users to choose from a set of methods for improving an outcome. Once users select a method, the system requires the user to define whether the method is a priority. These questions establish the beliefs of each user for what is needed to achieve their outcome. The system presents the percentage of users who chose the method as a top priority. The user is able to return to the methods menu and vote on other methods.

The system is used in a series of speed diagnostic cycles and correlates each priority and change in priorities by outcome. Outcomes are re-measured in each cycle. The system records and categorizes decision-making profiles of each user (e.g., fact-driven, early adopter, pivots frequently) to aid the user in how their decision-making category stands in performance in the short- and long-terms.

The system separates each organization's registered users, questions, and data. In addition, each organization may setup separate libraries. A library organizes the database by topics, outcomes and methods. Libraries may only be accessed by invitation. Each library encourages the reuse of metrics for the same topics, outcomes, and methods. Authorized users may create questions, which may be used within an organization's libraries. Each question appears in a configuration menu as an object. Each time the question is used by a group, the user is able to compare all prior answers with their current answer. The system allows authorized users to create private invitation-only groups, assign use cases and questions to the group. The administrator of the group may then send email invitations to registered members. The system offers each group a set of analytic tools, such as mobile apps, online diagnostics, and heat maps. Once members are registered to a group, they are sent different analytic tools in cycles.

The methods and systems can provide real-time responses to shared information, improving the likelihood users will continually use the system for reference and guidance. Benchmarking tools currently available do not offer the combination of: 1) self-configured topics, 2) immediate and visible data, and 3) a sophisticated database profile of a user's interests based on interactions. In the current environment for enterprise technology, broad categories spanning hundreds of sub functions and technologies are generally the only categories available to users when conducting benchmarking or vendor comparisons. The broad categories are set by research or consulting firms often with no online input from users. Moreover, surveys and benchmarks often separate data collection from data presentation, creating significant lag times between when the benchmark was first recorded and the present state of adoption.

Users can use the matching services in accordance with one or more embodiments to either find an expert or create a group for researching a specific issue or uncovering industry best practices.

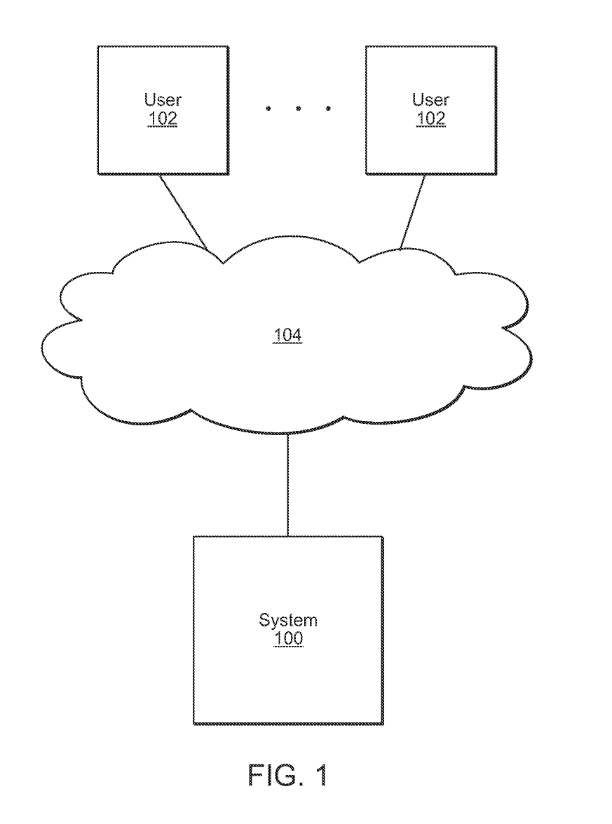

FIG. 1 illustrates an exemplary network, in which a computer-implemented system 100 in accordance with various embodiments may be implemented. The system performs the functions detailed in the various embodiments discussed below. The system is preferably implemented in a computer server system, which communicates with a plurality of client devices 102 operated by the users of the system. The computer server system can comprise a central server or a set of servers running system software and databases.

The client devices communicate with the system over a communications network 104. The communications network may comprise any network or combination of networks including, e.g., the Internet, a local area network, a wide area network, a wireless network, and a cellular network.

The client devices operated by users to access the system can comprise any computing device that can communicate with the computer server system including, without limitation, personal computers (including desktop, notebook, and tablet computers), smart phones, and cell phones. As is well known, such client devices include a processor, a storage medium readable by the processor, a display interface (a graphical user interface), and associated input devices such as a keyboard, a mouse, touchpad, or touchscreen for interacting with text or graphical elements shown on the display. Users can interface with the system through either a local browser or another remote application on their client devices. Through these devices users can provide, view, and interact with the information available in the system.

The databases run by the computer server system contain profile information about the users and data captured with respect to the topics, outcomes, and methods in the system.

The system combines analytics, interactive user charts, mobile accessibility, and intelligent filtering to offer large enterprises a smarter alternative to mass collaboration.

### Collecting and Sharing Real-Time Benchmarks Using a TOM Interactive, Analytic Model

In accordance with one or more embodiments, a computer-implemented system is provided for organizing data according to topics, outcomes, and methods and presenting the data in various interactive charts to users, e.g., on a browser supported user client device including on a mobile device. Using this unique structure, organizations may create sophisticated databases that build analytic profiles of users, track and rank experts, and enable matching and recommendations. The TOM methodology allows users to browse and create combinations of topics, outcomes, and methods to compare real-time benchmarks and seek expert matches for collaboration. Each interaction adds a record to the overall database and to the individual's database record.

In the TOM model, a topic is a major category that also may be quantified as a baseline for benchmarking. For example, IT Cost is a topic. The topic may be further reduced to “child” topics that may be mutually exclusive, collectively exhaustive sub-categories of the topic. For example, “Databases” is a sub-topic of IT Cost.

An outcome is a descriptive goal associated with the topic. It may also be a measurable goal and mathematical ratio for the selected topic. For example, the user may seek to “Lower Cost Per Employee” or “Increase Productivity Per Executive.” The system allows users to compare their ratios and automatically categorizes them into performance groups. These groups can be based on a visual bell curve where ratios are plotted against a frequency distribution.

A method is a description of the approach used to achieve the intended outcome. This approach may be a new technology, a different way of organizing teams, or a new process. Methods and their attributes are correlated to performance groups and monitored to enable users to identify the methods that lead to high and low performance.

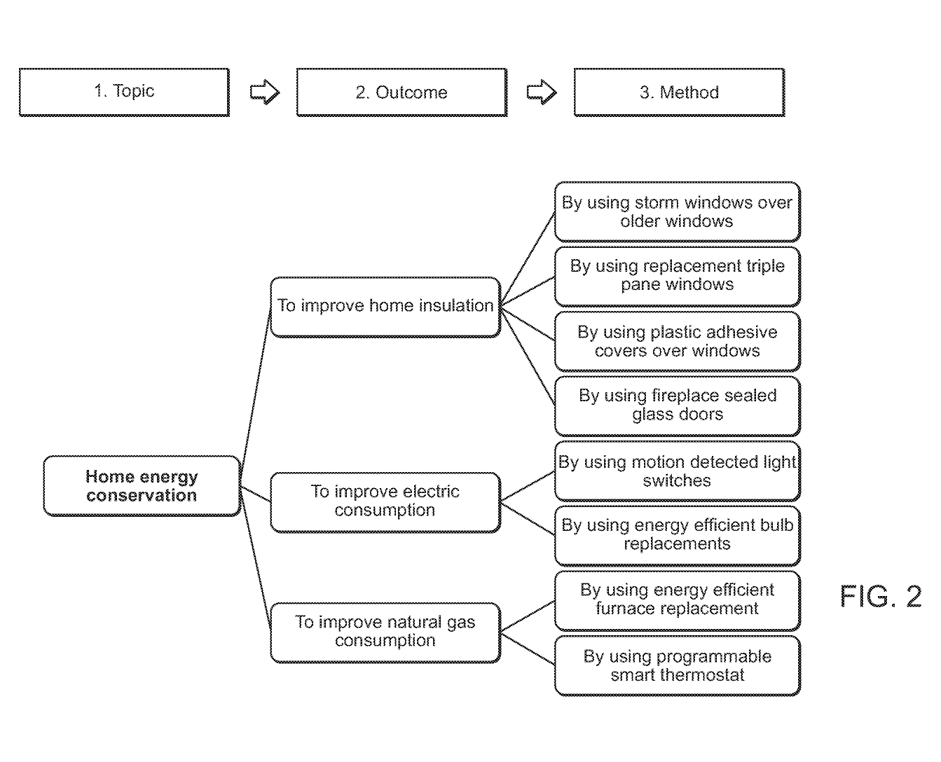

FIG. 2 illustrates a TOM model in the context of home energy conservation. This is by way of example only, as the TOM model is not limited to any particular industry or subject area.

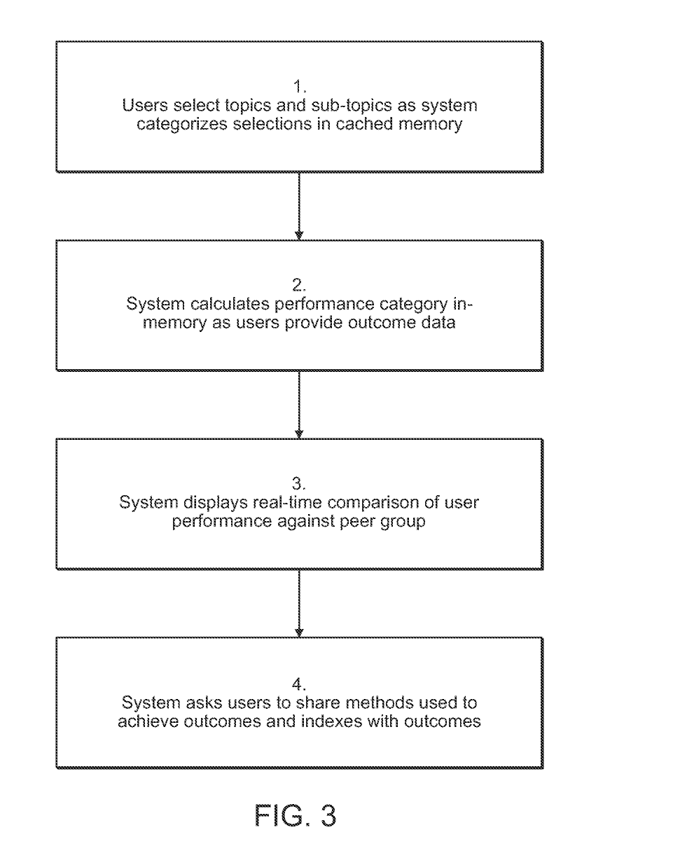

FIG. 3 is a simplified flowchart showing how the system allows users to use the TOM taxonomy to interact and see interactive data. As depicted in the flowchart, the system provides users various interactive charts to search topics, outcomes, and methods. The system displays discrete choices of topics and sub-topics. As the user selects these topics and sub-topics, the system continues to display outcomes and methods.

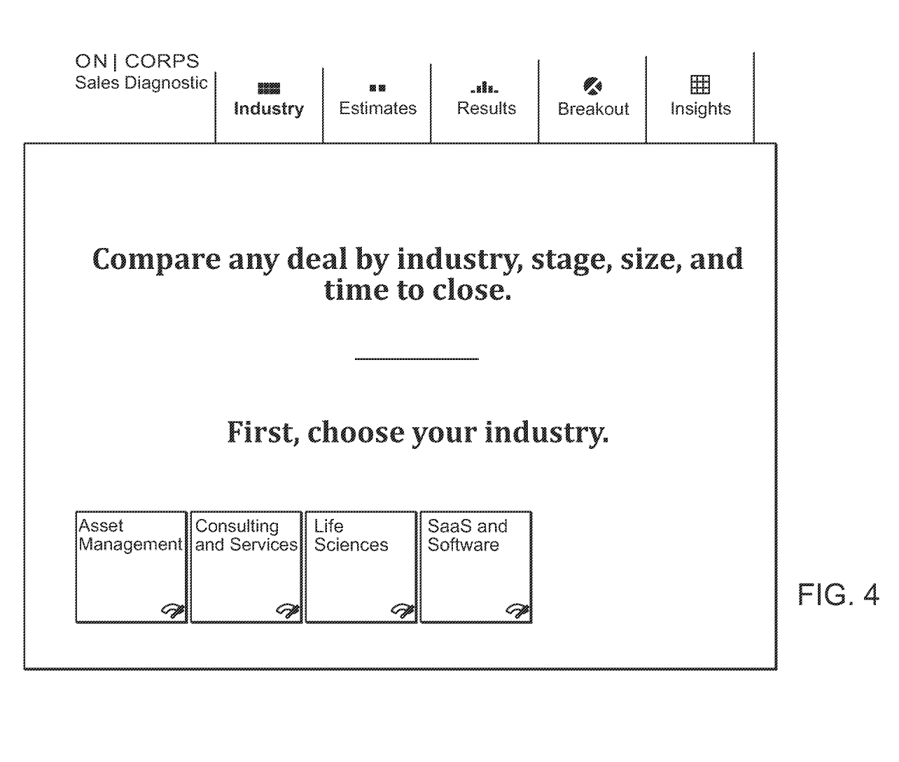

FIG. 4 illustrates an exemplary screen or window displaying interactive topics delivered from cached memory to the user. The system presents a series of boxes from which the user selects the topic of most interest. Once the user selects a topic, the system displays from cached memory the number of peers who have also selected the topic and whose data is stored in the system. The system continues to present boxes as more detailed libraries require sub-topic selections.

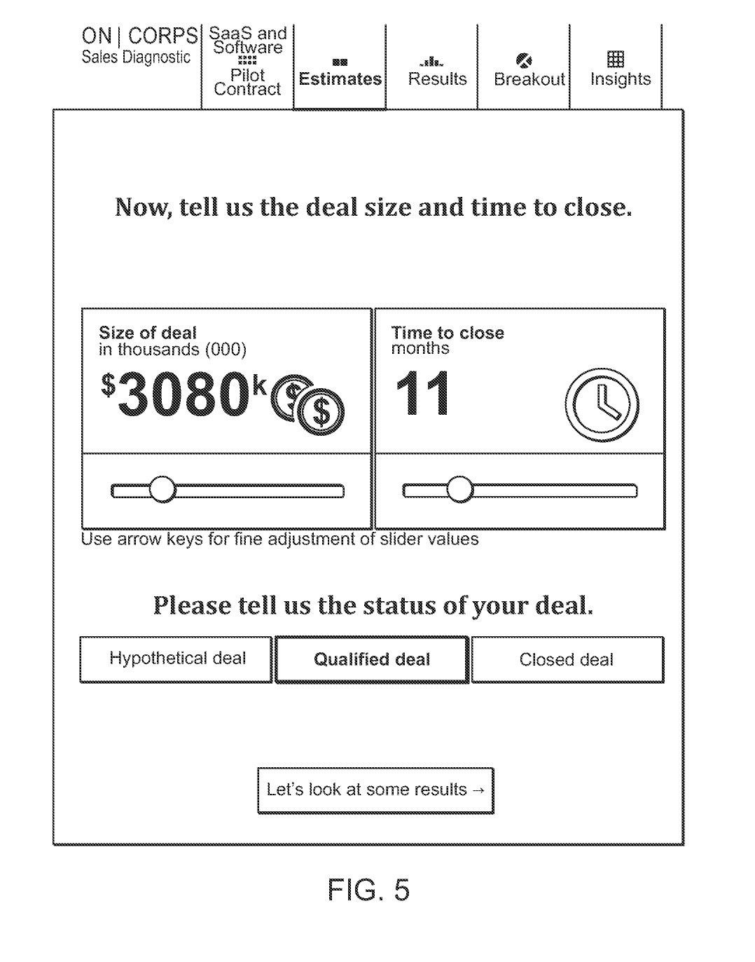

Once the user selects the topic and sub-topics of interest, the user is asked to share data on their outcomes for the given topic. FIG. 5 illustrates an exemplary display of outcome sharing dials for the user to share data. In this example, the system is configured to gather first-level input using two sliders, as the outcome under study is a ratio. The system also asks users to confirm their confidence level in the data.

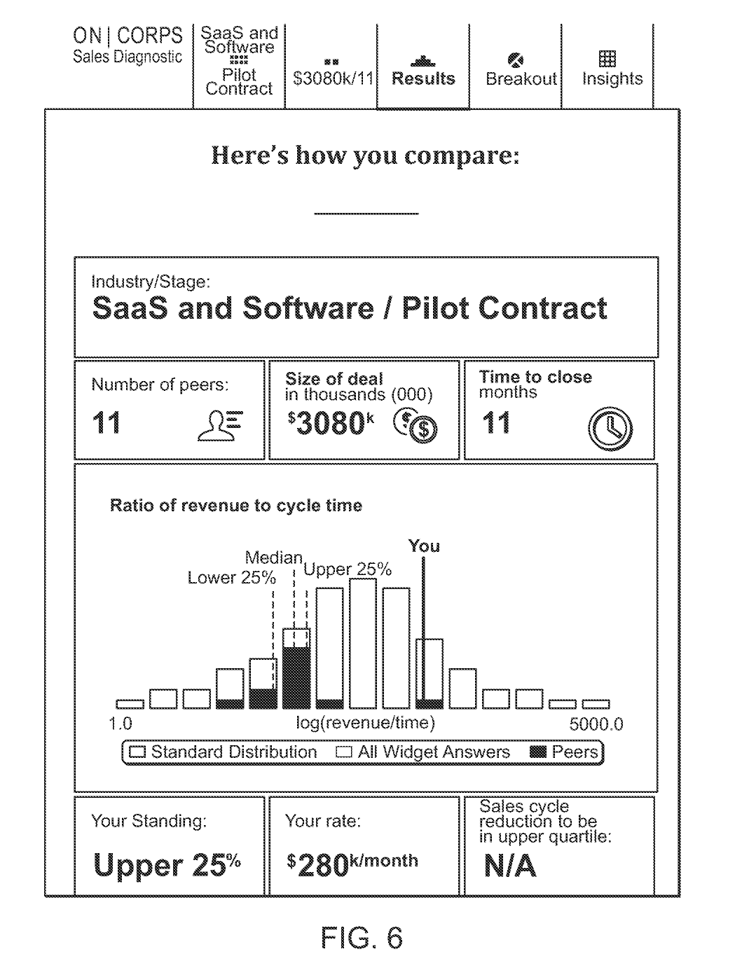

FIG. 6 illustrates an exemplary display of the user's performance compared to peers in the same topic and sub-topic category. The system calculates the user's outcome data with those of its peers in the same topic and sub-topic category and provides a real-time comparative display of where the user stands in terms of performance. In this embodiment, the system then prompts the user to register, where the performance data and benchmarks are recorded in a database record on the system's database server. Finally, the system asks users to select from a series of pre-defined methods that apply to their organizations. As they select methods, the system automatically categorizes them by the individual's performance ranking and displays percentages, correlations, and predictive probabilities.

### Organizing a Real-Time Private Library of Topics, Outcomes, and Methods and Exposing the Content to Targeted Groups Dynamically

A computer-implemented method and system in accordance with one or more further embodiments enables large organizations and others to create, populate, and manage a private library of topics, outcomes, and methods.

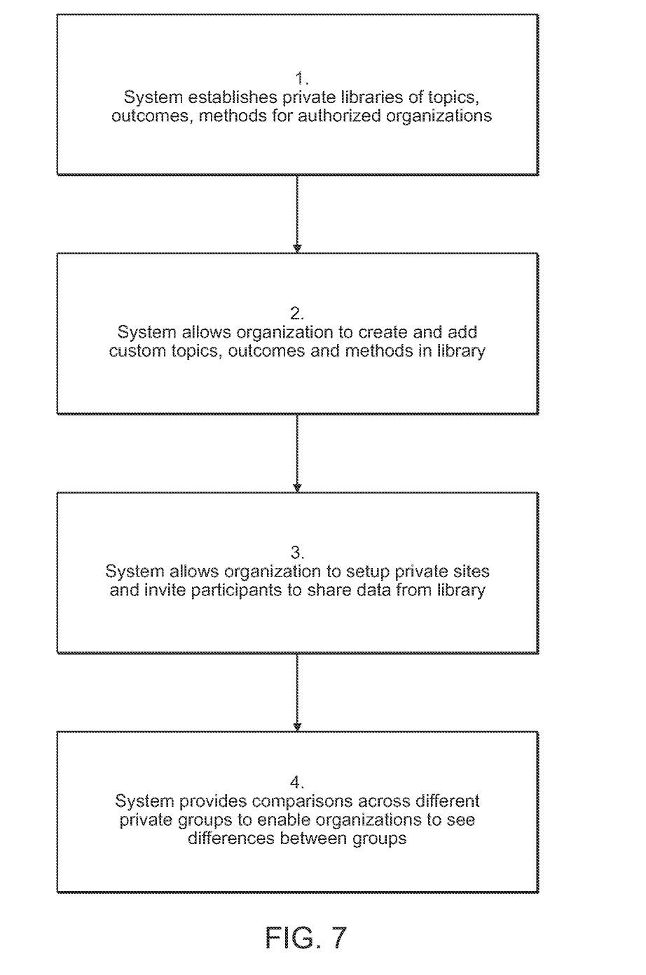

FIG. 7 is an exemplary flowchart illustrating use of a system for establishing private benchmarking libraries from which small invited groups may share benchmarks and be compared to one another. The system may be configured for an organization accounting for its various departments and sub-departments. A new library is a separated dataset of topics, outcomes, and methods created by an organization, which may only be accessed by authorized administrators, authors, and invited participants. Once the library is established, the system enables private sites to be created, which present invited users a series of interactive charts from which to share benchmarking information. Each private site may use topics, outcomes, and methods created for the library or may choose to add new content to the library. Each private site therefore adds to the library in both data and new content. Finally, each private site may choose to link with another site and share select information. This capability enables organizations to compare perspectives from different teams dynamically while protecting the privacy of both individuals and private site teams.

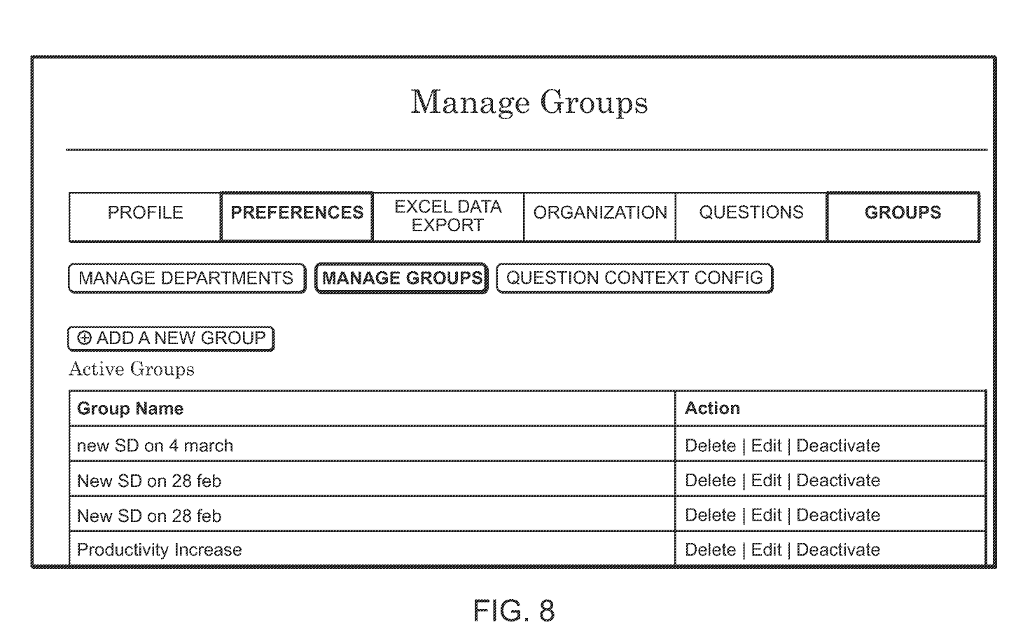

FIG. 8 illustrates an exemplary screen or window enabling a private library to be set up for an organization. The organization may segment the library by department, enabling organizational comparisons and authorizations to benchmark information. The system creates separated data sets with unique authorizations and access to organizations. The authorized administrator may add a department or sub-department to the library. This allows the organization to compare benchmarks automatically by department and sub-department. In addition, the system lets administrators set up private site speed diagnostics, which are indexed by department. Speed Diagnostics allow organizations to conduct a specific series of interactive benchmarks that are chosen by the sponsor and presented only to those invited. Benchmarks show only data for that group and may compare the group to an overall benchmark or to another group. The sponsor may then add new benchmarks over time as the participants remain connected.

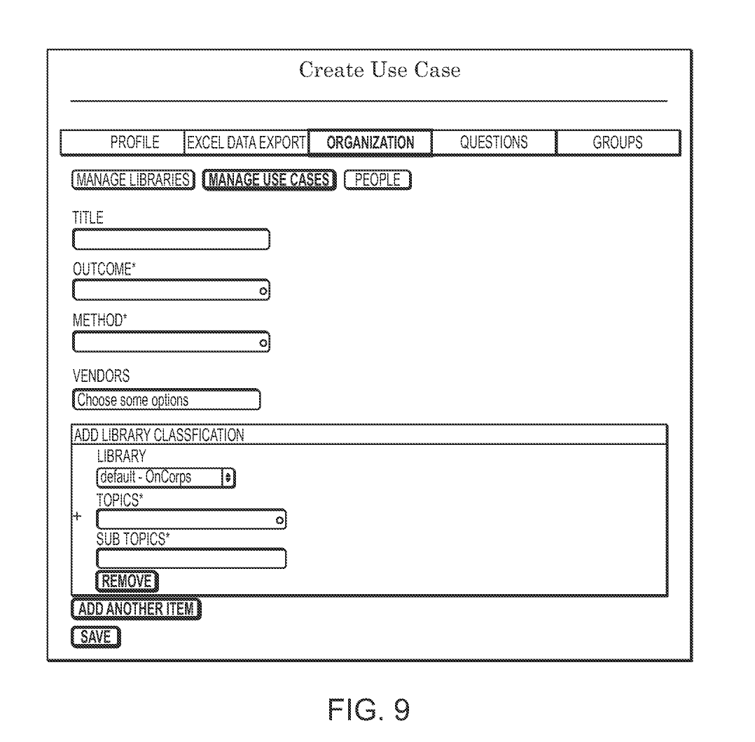

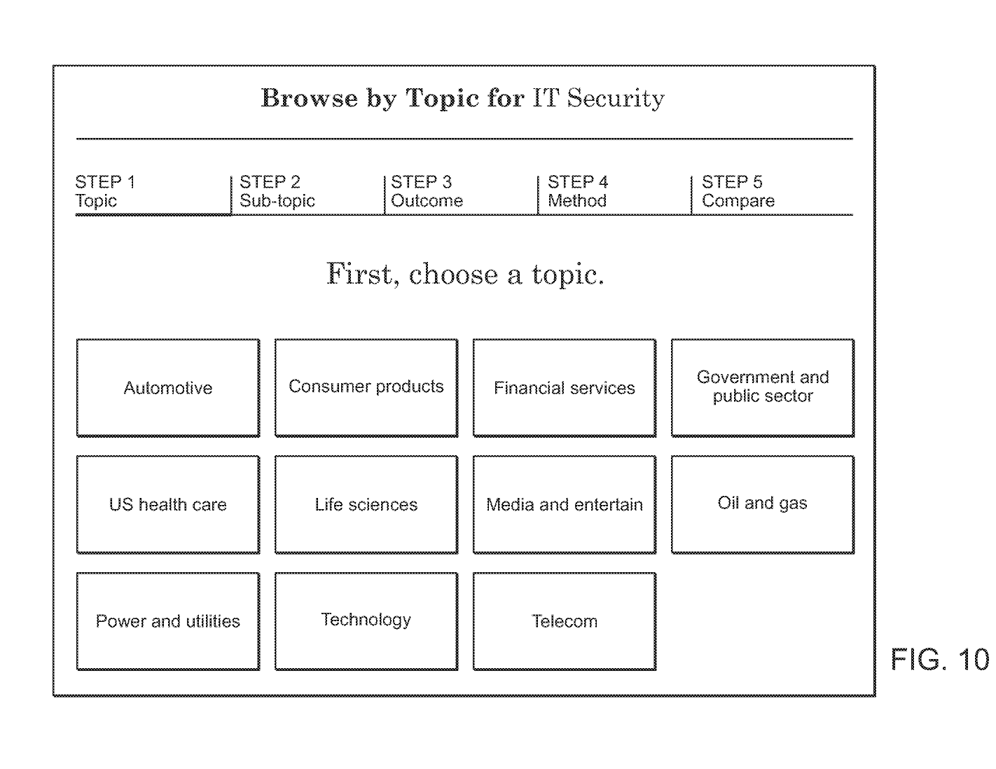

FIG. 9 illustrates an exemplary screen allowing authorized participants in a private library an ability to write new topics, outcomes, and methods to be added automatically to the library. As shown, the system enables users to create new topics, outcomes, and methods if they do not see a TOM combination that meets their needs. Once the user describes these new combinations, the system automatically adds the content to the library, where other teams and individuals may share benchmarks against the new content. FIG. 10 illustrates an exemplary screen or window where users select a topic, outcome, method combination and see data panels where they may share-and-compare benchmark data pertaining to that particular combination.

### Matching Experts by Using Dynamic and Anonymous Expert Matching Database Filters

In accordance with one or more embodiments, a computer-implemented method and system are provided for maintaining a detailed mathematical fingerprint of topics, outcomes, and methods and their associated attributes, by individual. A mathematical fingerprint is a unique analytic profile of each user's interests and expertise. The fingerprint includes activities in various combinations of topics, outcomes, and methods. Topics are specific data categories such as types of technologies with which an IT executive may be expert. In addition, outcomes are ratios of performance where the fingerprint records the user's ranking. Finally, detailed root cause attributes are recorded in the fingerprint. This may include, e.g., the executive's role in a particular technology. Each user is registered, and each interaction with the user is recorded in a personal database record for the user. The system allows users to share data and see benchmarks instantly while protecting the identity and information of users. As users interact with the application, the system displays anonymous matches of other experts. The system then allows users to select specific matches and send messages to others. These information requests are queued in a messaging table in individual dashboards. In one or more embodiments, the messaging table provides three tabs: (1) “You're Still Waiting,” which shows, in order of time sent, messages the user has sent but not yet received responses from, (2) “They're Still Waiting,” which shows in order of time sent, messages sent to the user which he/she has not yet responded to, and (3) “History,” which shows a log of interactions by topic and date. The system also maintains user statistics on areas of expertise and comparative demand levels for information.

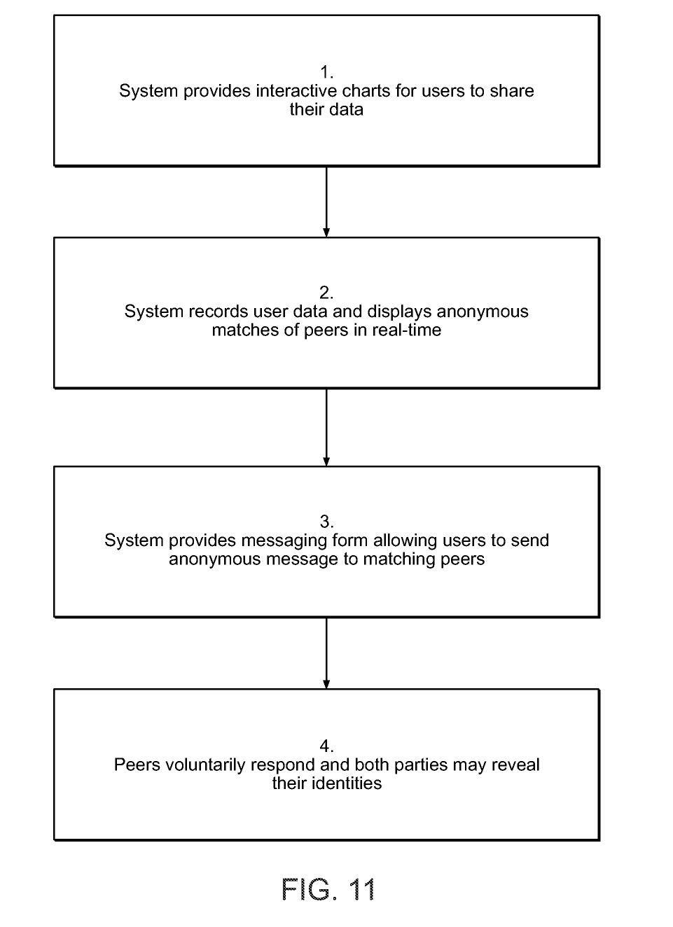

FIG. 11 is a simplified flow chart illustrating a matching workflow for experts in accordance with one or more embodiments.

A user may search for one or more experts or peers to contact directly about their experience with a specific use case or other element associated with the use case (e.g., vendor). The system filters experts according to the criteria set by the user, which can include the importance of certain criteria such as industry, size of organization, role of expert, and vendor/technology.

The system filters the community into a set of matches by taking the entire community or a defined subset of the community (e.g., only current employees of a specific company) and removes individuals who do not meet the specified matching criteria. Users may elect to view the number of matches and refine their criteria based on this outcome. The system can also indicate the number of individuals at each elimination stage, so that specific criteria can be modified if too many individuals are being excluded at that filtering stage.

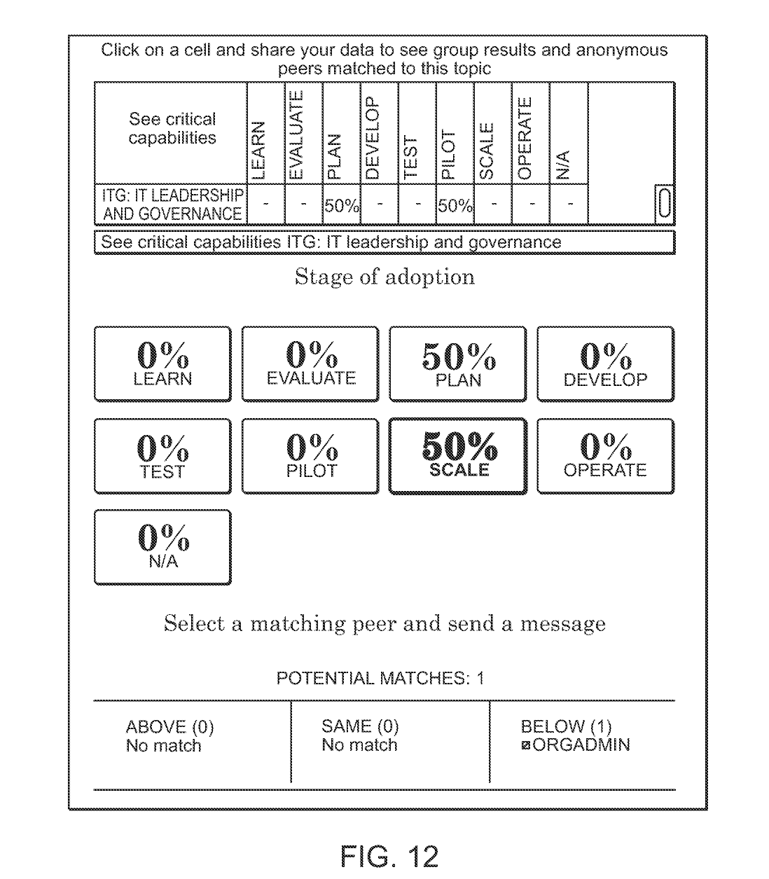

FIG. 12 is a simplified diagram illustrating the user-controlled matching process, filtering peers out based on the user-defined criteria.

Users can also elect to receive recommended matches from the system, based on their mathematical fingerprint. The mathematical fingerprint allows the user to see only the most relevant matches based on their own attributes. Example attributes could include: industry, role, size, use case, vendor, and roadblock.

### Tracking Beliefs, Observations, and Responses and Correlating to Performance

In accordance with one or more embodiments, a computer-implemented system is provided that presents to users operating client devices real-time performance comparisons with peers by tracking user beliefs, observations, and responses to their performance against peers. The system operates in a series of cycles, where each user is asked to input the same outcome information each cycle (e.g., their weight, project progress, or sales bookings). The system tracks beliefs of users relating to the improvement of the outcome by asking the users to compare methods for achieving the outcome and to define their priorities. The system then provides real-time charts to users, such as heat maps and Gaussian curves, allowing them to observe the popularity and performance ranking of chosen priorities as compared to others. Finally, responses to these observations are recorded in an analytic database. Responses to observations are determined by measuring the changes in priorities and through direct questions about actions they have taken.

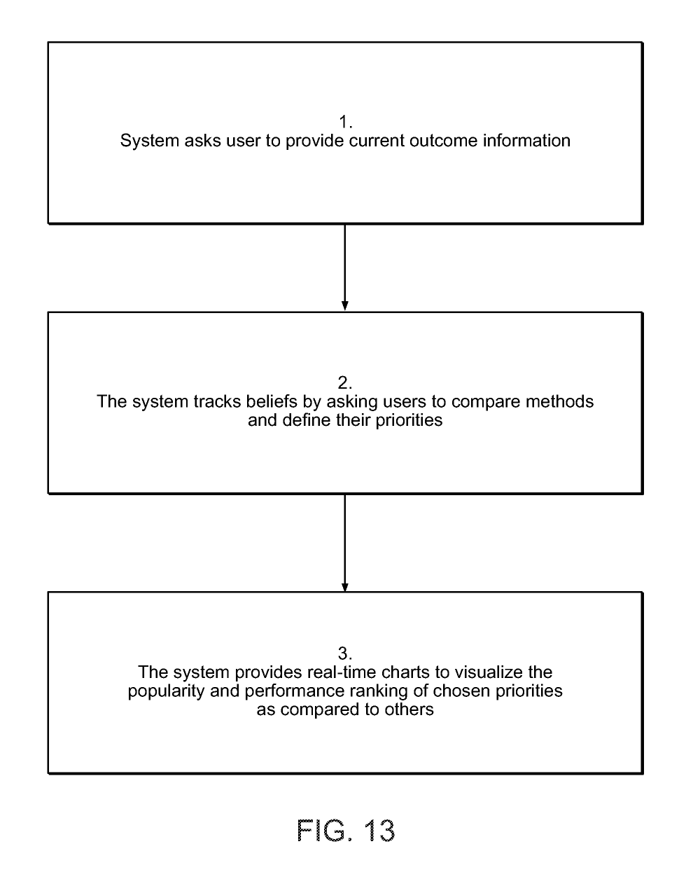

FIG. 13 is a simplified flow chart illustrating an example of how the system presents and tracks beliefs, observations, and responses.

The system first presents a series of profile questions (e.g., role, office, region) to each user, the responses to which are recorded in the database as contexts. Depending on the configuration of the system, contexts can be used to automatically group users and/or determine matches. Contexts can also determine which questions a user will be asked or which results are shown to the user.

The user sees a real-time view of the responses for each question or context, which is retrieved from the database by means of a real-time asynchronous call to the analytic database. The system then allows the user to input their current state performance of an outcome, and this data is added to the user's profile in the analytic database in real-time. The system then automatically ranks the user's performance metric with peer metrics via a real-time asynchronous call to the analytic engine, based on one or more statistical algorithms employed in the system.

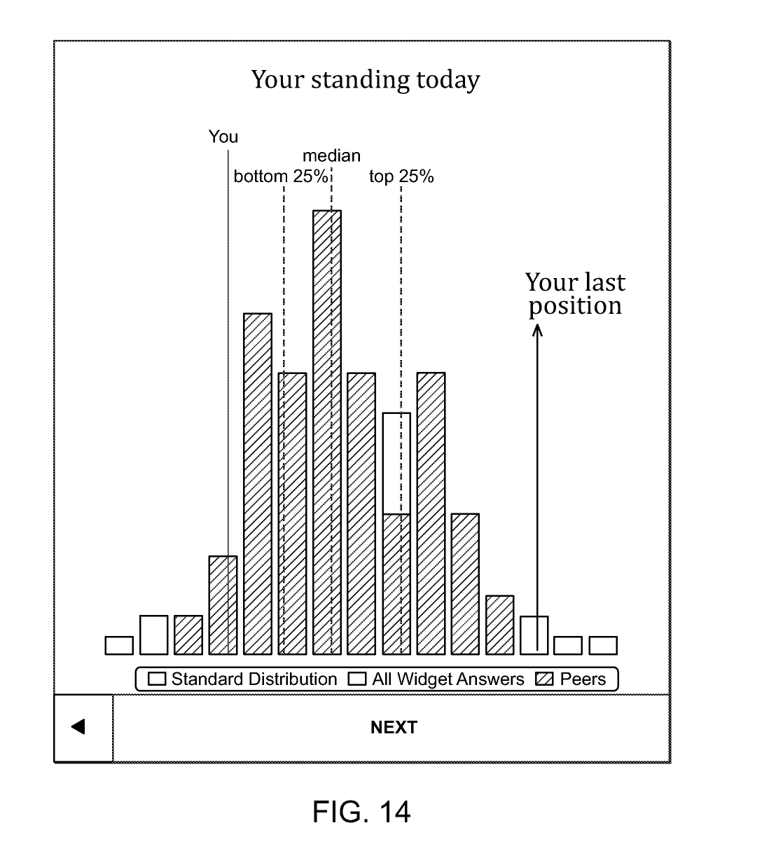

FIG. 14 is a screen or window shown to a user, illustrating an example of how the system presents the user's relative standing on a Gaussian curve in accordance with one or more embodiments. The exemplary screen or window displays the user's plotted position on the curve in addition to the quartile markers and the user's change from the last cycle.

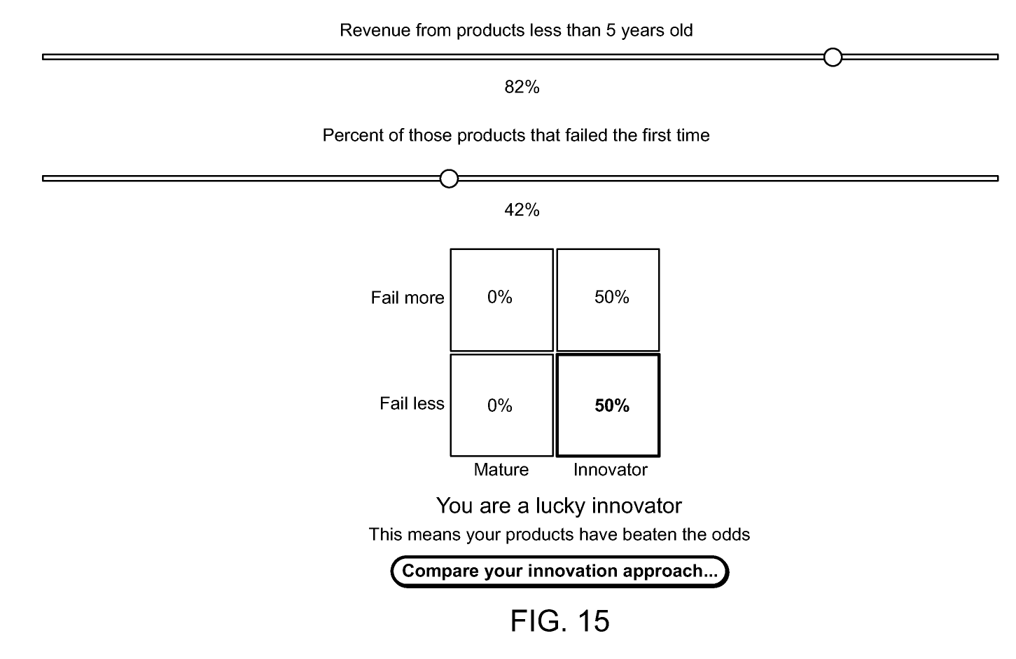

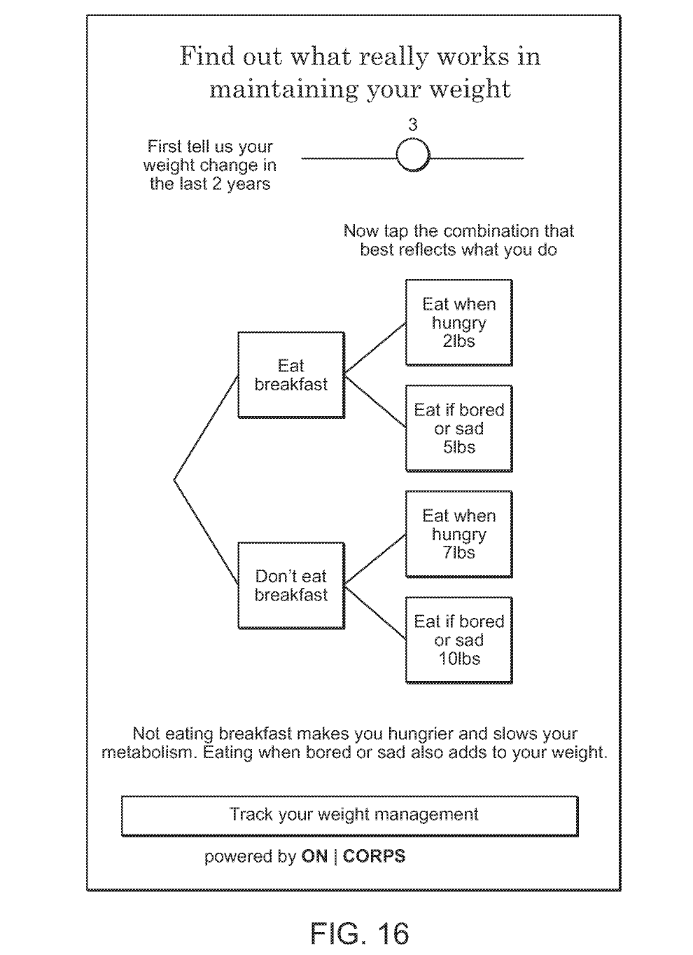

Other types of charts may also be presented to users for quantitative comparison. For instance, as shown in FIG. 16, a decision trees can be displayed to users with actual outcomes by branch shown in real-time as the user makes selections. Also, as shown in FIG. 15, a 2×2 matrix may be displayed to users showing them real-time which quadrant the user is in based on his or her inputs.

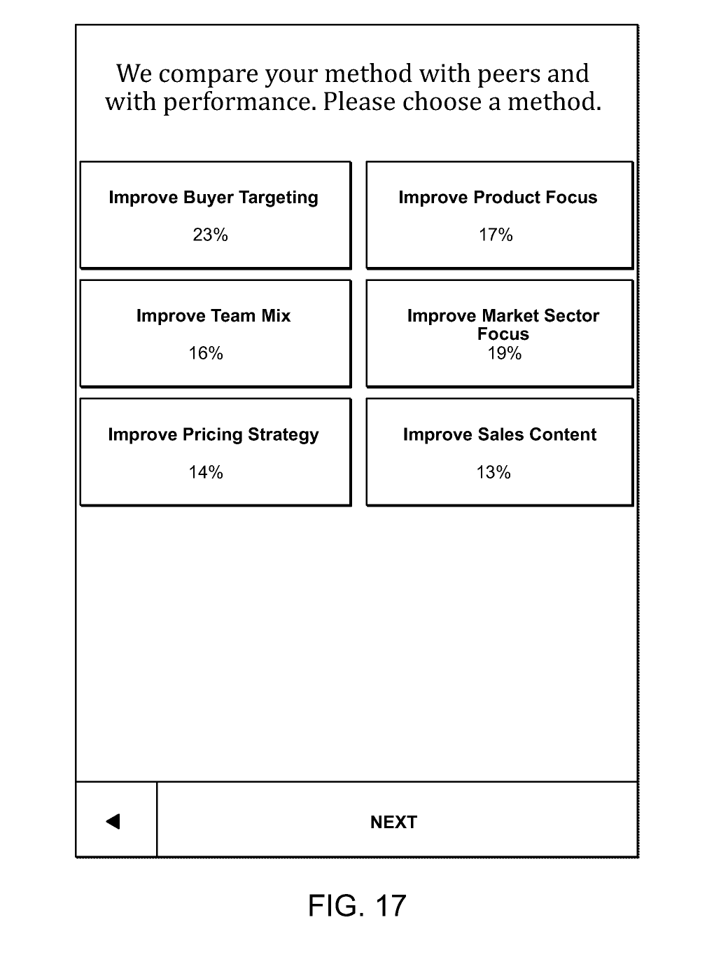

As shown in FIG. 17, the system also presents the user with alternative methods to achieve the desired outcome, each defined by the administrator. The methods each describe a possible belief relating to the improvement of the outcome. When the user selects an alternative method, the system presents the real-time results of responses from users showing the popularity of each method, incorporating the user's response as shown by the percentage numbers in the figure.

Once a method is selected, the exemplary system prompts the user to describe whether this method is a priority. The user may choose between a range of pre-configured answers. In one embodiment, the user can choose either YES, NO, and ONLY IF. For each selection, the system then displays branching questions based on their previous answers. Each question is intended to track decision-making profiles for the user (e.g., the user's degree of conviction, whether they are an early adopter, etc.) The ONLY IF branch tracks the believed conditional factors needed to change and make the method a priority for the user. The system uses this data to inform the organization to which the users belong of the barriers to adopting certain practices or solutions. It is also used to provide intelligent alerts to each user when those conditions have been met.

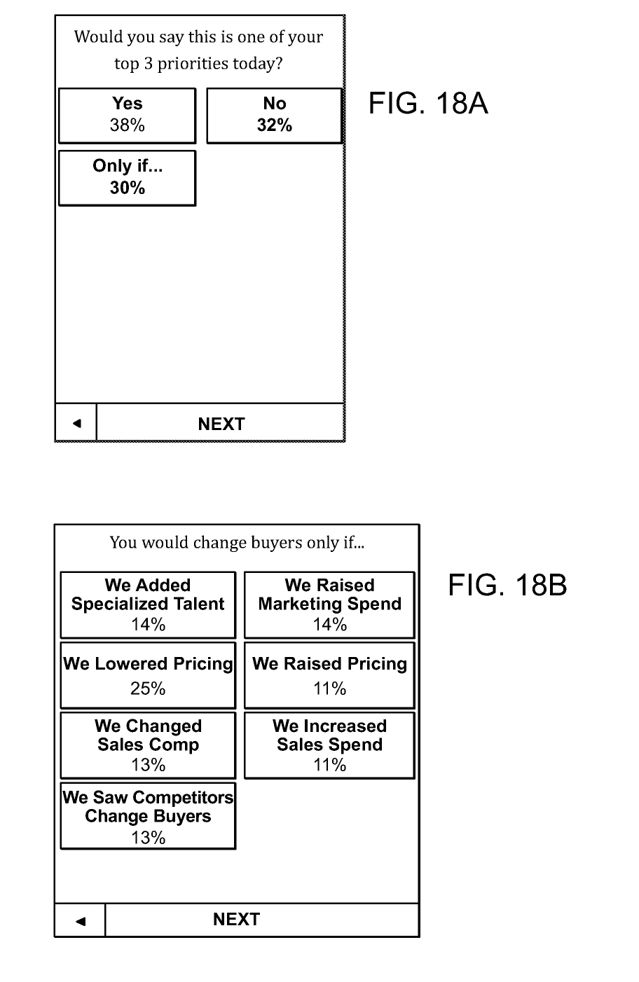

FIGS. 18A and 18B are screens or windows showing an example of how the system presents the YES, NO, ONLY IF questions and branching questions to the user. If the user selects ONLY IF in FIG. 18A, he or she is presented with FIG. 18B, which requests information on conditional factors relating to the priority.

The decision making profiles of each user can be specified in pre-defined and quantitatively compared sets (e.g., populist v. contrarian, early adopter v. late follower, pivoter v. sticking-to-plan). The profiles may be displayed in a Gaussian curve. The profile of a user may be compared to profiles of other users and may be correlated to outcomes (e.g., do early adopters win more?). The profile of a user can also be tracked over time. The system presents these quantitative profiles to users as a unique way of providing insight into how the user, their team, and their customers make decisions.

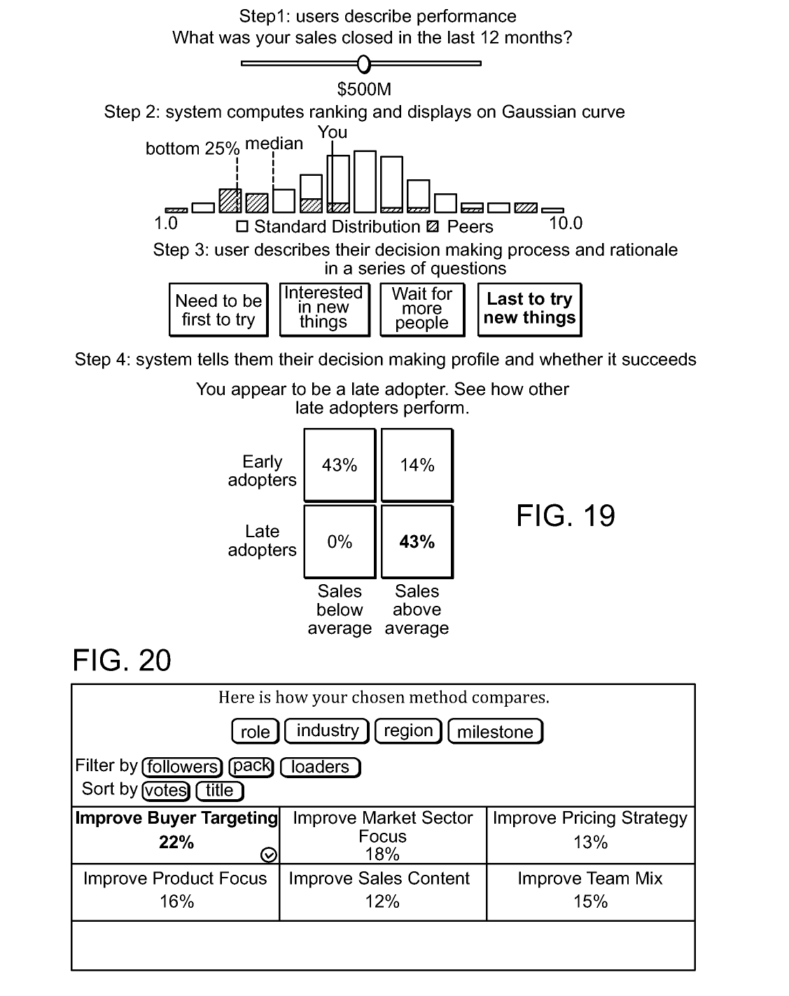

FIG. 19 is a step-by-step diagram illustrating an exemplary process for determining and displaying a decision making profile for a user in accordance with one or more embodiments. The user first inputs information about his or her performance. The system then computes rankings of the user's performance relative to other users and displays the information in a Gaussian curve. The system then receives an input from the user describing his or her decision-making process and rationale through a series of questions. Finally, the system determines the user's decision-making profile and can indicate whether it succeeds.

Once the user selects a method, the system presents a chart, such as a heat map, from which the user may see how their selected method compares with peers as shown in FIG. 20. In one or more embodiments, the system presents the data in color-coded boxes, where each box is a different method, so users can quickly visualize the leading methods. In addition, the heat map may display and re-sort results by any question, context, or statistical measure (e.g. leaders as determined by top quartile performance results). The user may select one or more questions, contexts, or statistical measures and see the results of the union of these selections. Each question, context, or combination thereof, retrieves data from memory by means of a real-time asynchronous call to the analytic database.

Once the initial cycle is completed, the system continues to send periodic messages and alerts to the user, prompting them to update their outcomes and methods. Each interaction compares their last outcome and method using two computational processes in the system. The first is a correlation of the methods with the outcomes of the peers at the present time, to determine how the user's method is performing. The second algorithm compares the user's current outcome with changes in top performers' outcomes, to determine the predicted performance of the selected outcome and recommend alternative outcomes which may lead to higher performance. The context of the user and the user's past performance metrics also contribute to the recommendation in the analytic engine of the system.

Over a number of cycles, the exemplary system presents updates to the user describing their decision-making profile and how others with a similar profile stand in performance quartiles on a given outcome.

### Creating Configurable and Branched Mobile and Responsive Web Applications

In accordance with one or more embodiments, a computer-implemented system is provided that allows users to configure new mobile and responsive web applications with no technical programming skills. The system allows an authorized user to use online forms to create questions, sequencing, and branching of questions for users to see on a user client device such as a mobile device.

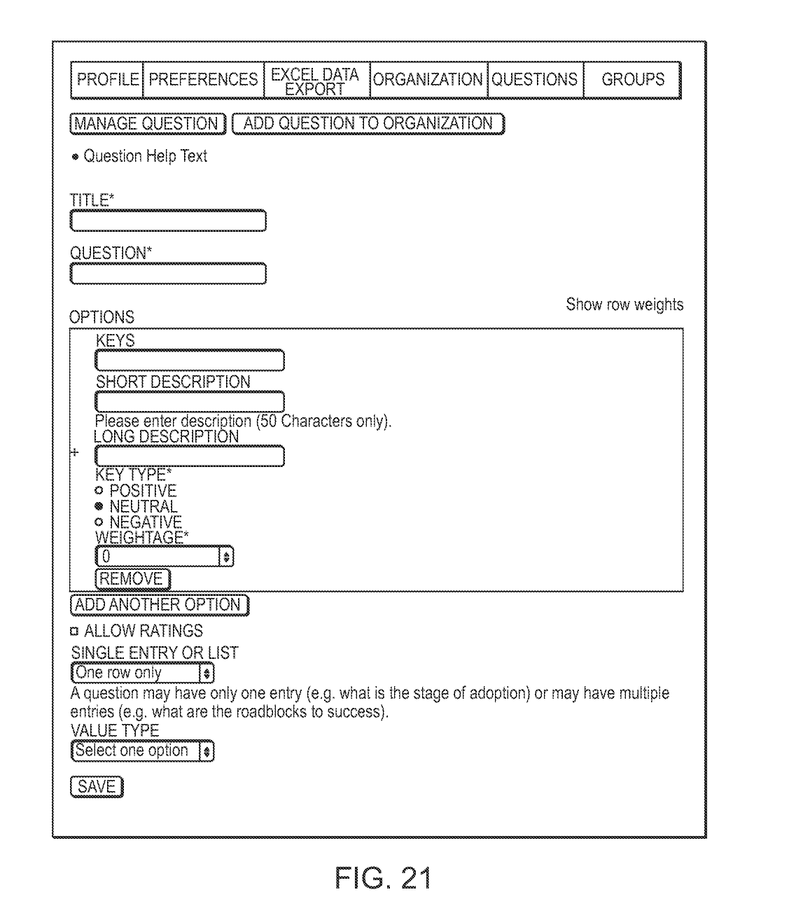

FIG. 21 is a screen or window showing how the system enables authorized users to create questions that are configured in an application in accordance with one or more embodiments.

The system presents the authorized user with an ability to select the sequence and branching of questions and interleave these with a preconfigured set of charts that include insightful analytics, e.g., a Gaussian curve showing the user's performance standing or a heat map showing the ranking of a user's method versus leaders.

Once the application is configured, an authorized user may deploy the application to users. The system presents this application in the form of a URL. The URL is created through an administration interface that allows the deployed application to be targeted at a specific user population that, by virtue of using the application, are added to a specific grouping within the analytic database. This contributes to the user's profile for use in messaging, alerts and analytics using computational processes built into the analytic engine.

### Summary

The processes of the various systems described above may be implemented in software, hardware, firmware, or any combination thereof. The processes are preferably implemented in one or more computer programs executing on a programmable computer (which can be part of the computer server system) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A computer-implemented method for tracking performance of a plurality of users, each of said users operating a computer client device communicating with a computer server system over a communications network, the method, performed by the computer server system, comprising the steps of:
(a) receiving responses to one or more profile questions from each of said plurality of users and storing the responses in a database as part of each user's profile;
(b) receiving from each of said plurality of users information on performance of the user in a given time cycle relating to a specified outcome, and storing the information in the database as part of the user's profile;
(c) comparing the information on the performance of the user to information stored in the database on the performance of other users to generate a performance comparison, and presenting a graphical representation of the performance comparison to the user in real-time to step (b);
(d) presenting to the user a set of alternative methods for potentially improving achievement of the outcome, receiving a response from the user with a selected alternative method, and presenting to the user in real-time information on the popularity of the alternative methods as selected by the other users; and
(e) repeating steps (b) through (d) for a plurality of time cycles.

2. The method of claim 1, further comprising determining a decision making profile for each user and displaying the decision making profile to the user analytically as an aid to improving performance.

3. The method of claim 2, further comprising tracking the decision making profiles of each user over time.

4. The method of claim 2, further comprising comparing the decision making profile of a user to the decision making profiles of other users and corresponding outcomes, and displaying results to the user.

5. The method of claim 1, further comprising grouping users for performance comparison based on responses to profile questions received from the users.

6. The method of claim 1, further comprising determining which information will be requested from or presented to a user based on the user's profile.

7. The method of claim 1, wherein the graphical representation of the performance comparison comprises a Gaussian chart, a decision tree, or a two-axis matrix.

8. The method of claim 7, wherein the Gaussian chart includes quartile markers.

9. The method of claim 7, wherein the Gaussian chart indicates the user's performance during one or more previous time cycles.

10. The method of claim 1, further comprising prompting the user to indicate whether the selected alternative method comprises a priority.

11. The method of claim 10, further comprising receiving a response from the user as to whether the selected alternative method is a priority, said response indicating that the selected alternative method is a priority, is not a priority, or is a priority only if a given condition is met.

12. The method of claim 11, further comprising notifying the user when the given condition has been met.

13. The method of claim 1, wherein the real-time information on the popularity of alternative methods selected by other users is presented to the user in a graphical format.

14. The method of claim 13, wherein the graphical format comprises a heat map.

15. A computer system, comprising:
at least one processor;
memory associated with the at least one processor; and
a program supported in the memory for tracking performance of a plurality of users, each of said users operating a computer client device communicating with the computer system over a communications network, the program containing a plurality of instructions which, when executed by the at least one processor, cause the at least one processor to:
(a) receive responses to one or more profile questions from each of said plurality of users and store the responses in a database as part of each user's profile;
(b) receive from each of said plurality of users information on performance of the user in a given time cycle relating to a specified outcome, and store the information in the database as part of the user's profile;
(c) compare the information on the performance of the user to information stored in the database on the performance of other users to generate a performance comparison, and present a graphical representation of the performance comparison to the user in real-time to step (b);
(d) present to the user a set of alternative methods for potentially improving achievement of the outcome, receive a response from the user with a selected alternative method, and present to the user in real-time information on the popularity of the alternative methods as selected by the other users; and
(e) repeat steps (b) through (d) for a plurality of time cycles.

16. The computer system of claim 15, wherein the program includes further instructions to cause the at least one processor to determine a decision making profile for each user and display the decision making profile to the user analytically as an aid to improving performance.

17. The computer system of claim 16, wherein the program includes further instructions to cause the at least one processor to track the decision making profiles of each user over time.

18. The computer system of claim 16, wherein the program includes further instructions to cause the at least one processor to compare the decision making profile of a user to the decision making profiles of other users and corresponding outcomes, and display results to the user.

19. The computer system of claim 15, wherein the program includes further instructions to cause the at least one processor to group users for performance comparison based on responses to profile questions received from the users.

20. The computer system of claim 15, wherein the program includes further instructions to cause the at least one processor to determine which information will be requested from or presented to a user based on the user's profile.

21. The computer system of claim 15, wherein the graphical representation of the performance comparison comprises a Gaussian chart, a decision tree, or a two-axis matrix.

22. The computer system of claim 21, wherein the Gaussian chart includes quartile markers.

23. The computer system of claim 21, wherein the Gaussian chart indicates the user's performance during one or more previous time cycles.

24. The computer system of claim 15, wherein the program includes further instructions to cause the at least one processor to prompt the user to indicate whether the selected alternative method comprises a priority.

25. The computer system of claim 24, wherein the program includes further instructions to cause the at least one processor to receive a response from the user as to whether the selected alternative method is a priority, said response indicating that the selected alternative method is a priority, is not a priority, or is a priority only if a given condition is met.

26. The computer system of claim 25, wherein the program includes further instructions to cause the at least one processor to notify the user when the given condition has been met.

27. The computer system of claim 15, wherein the real-time information on the popularity of alternative methods selected by other users is presented to the user in a graphical format.

28. The computer system of claim 27, wherein the graphical format comprises a heat map.
